(19) United States
(12) Patent Application Publication
(10) Pub. No.: US 2010/0327854 A1
(43) Pub. Date: Dec. 30, 2010

(54) DEVICE FOR DETERMINING THE POSITION OF AN OBJECT WITH AN ENLARGED MEASUREMENT RANGE

(76) Inventors: Werner DENGLER, Nueziders (AT); Bastien WALSER, Feldkirch (AT)

Correspondence Address: KF ROSS PC, 5683 RIVERDALE AVENUE, SUITE 203 BOX 900, BRONX, NY, 10471-0900, US

(21) Appl. No.: 12/494,445

(22) Filed: Jun. 30, 2009

(30) Foreign Application Priority Data
Jun. 30, 2009 (DE) 102008030295.3

(51) Int. Cl. G01B 7/30

(52) U.S. Cl. 324/207.2

(57) ABSTRACT

The invention concerns a device (1) for determining a position of an object that is provided with a Hall probe (2) as well as with a switching magnet (3) that works together with the Hall probe (2), whereby, in accordance with the invention the Hall probe (2) that has Hall plates is provided with differential sensors that react to the field differences between the Hall plates.

The invention concerns a device for determining a position of an object, the device having a Hall probe as well as a switching magnet that works together with the Hall probe according to the characteristics of the introductory clause of claim 1.

Absolutely measuring Hall probes that are used as switches have narrow limits with respect to operating distance, i.e. the distance between the Hall probe and the switching magnet that works with it. Increasing operating distance worsens the susceptibility to interference, and there are limits beyond which a certain specified magnetic flux is not attained. In addition, manufacturing tolerances of automated Hall probes that are produced in large-scale mass production are responsible for steady worsening of the specified characteristics.

As a rule, in the device that is to be improved, the known Hall probe for measuring magnetic fields and currents or for determining a position is however to be used. When electricity flows through a Hall probe and it is placed in a magnetic field that runs perpendicular to it, it supplies output voltage to an evaluation circuit whose output voltage is proportional to the product of the magnetic field strength and the electric current. If the applied electric current is known, one can then measure the magnetic field strength. If the magnetic field is created by a conductor through which the electric current flows, or an inductor, one can measure the strength of the voltage in that conductor or the inductor potential-free. A Hall probe supplies a signal even when the magnetic field created by the switching magnet is constant. This is the decisive advantage compared with a pairing of a magnet and an inductor. As soon as the magnet is not displaced, the voltage induced by the inductor is zero. Therefore, the magnet is not recognized.

In the automobile industry, Hall probes are often used, for example, in belt buckles, door-locking systems, in the recognition of the pedal status, in gear switching and for the recognition of the ignition point in combustion engines. The primary advantage of such Hall probes is their insensitivity with respect to (non-magnetic) dirt and water as well as temperature fluctuations and vibrations.

An application of a Hall probe (designed as a magnet switch) is known from EP 1 577 178. This European application reveals a belt buckle switch for recognizing the status of whether a lock of a safety belt buckle of a vehicle is open or closed, a switching magnet being provided for determining the status of the buckle lock. This magnet switch is actuated when the clasp of the belt is in direct proximity of the magnet switch. Conversely, this means that the belt lock switch detects an open belt when the clasp is not in direct proximity of the magnet switch.

The invention is based on the problem of improving a device in accordance with the described type so that the operating distances can be enlarged, and the insensitivity to interference and the reproducibility are maintained and especially, are also intended to be improved.

This problem is solved by the characteristics of claim 1.

In accordance with the invention the Hall probe is provided with at least two Hall plates with differential sensors that react to field differences between the Hall plates. This reaction takes place when the device in accordance with the invention for determining the position of the object is moved relative to the object itself. This way, a variant is conceivable that the device for determining the position of the object to be measures is mounted fixed and not displaceable and that the object can be displaced relative to it so that the switching magnet mounted on the object is formed by the object itself or is integrated into the object. The other case is also conceivable, in that the object is fixed with the switching magnet, while the device for determining the position of the object is displaceable relative to it.

The solution in accordance with the invention is thus based on abandoning the absolute measurement known in the prior art in favor of a relative measurement. This design is favored by the differential sensors in accordance with the invention that react to field differences between their two Hall plates.

In the further development of the invention, the differential sensors are designed to switch near zero, so that switching on takes place when a magnetic flux passes through the switching magnet and switching off takes place when the magnetic flux inverts. As a result of this construction of the magnetic circuit, the effect is enhanced, and in a particularly advantageous manner, making it reproducible for devices for determining the position of objects to be measured that are manufactured in large quantities (mass production) and in particular, are manufactured automatically.

In a further development of the invention, a magnetism-boosting flux collector is located near at least one of the Hall plates. Near at least one Hall plate, a magnetism-boosting flux collector is thus used that is responsible for an asymmetric field buildup. It ensures that a switching point is also safely attained for larger and thus greater distances between the device for determining the position of the object and the switching magnet, so that with it, the susceptibility to interference at larger distances is maintained or even increased.

In a further development of the invention, an erasing magnet is provided. Depending on the application, as shown here, an additional erasing magnet can be used that forces the resetting of the system when the magnetic target is missing (a switching magnet mounted on the object).

In a further development of the invention, the Hall probe has a reset magnet. The Hall plate that is preferably designed as a ferromagnetic disk mounted on the upper side of the Hall probe attracts the magnetic flux and the field strength that is created there is sufficient in order to actuate a differential Hall-effect switch (Hall probe with differential sensors). Also, the reset magnet is still required in order to guarantee a safe resetting from one switching status to the other switching status.

With the design of the reset magnet, particularly its size, its magnetic field and its location, the distance (operating distance) can also be influenced in the range in which the Hall probe starts to operate, i.e. the distance that must be attained or exceeded so that the Hall probe goes from one switched status to the other switched status.

The switching behavior of the device for determining a position of the object, also called the wide-range Hall switch, is determined in advantageous manner by the shape of the highly permeable disk, the position of the reset magnet, and the strength of the switching magnet.

From this, advantages result so that the range at which the switching magnet, i.e. the position of the object relative to the Hall probe can be detected, is many times larger than in conventional prior-art systems. An additional advantage is that the overall size must not absolutely be larger than the overall size of existing sensors.

The application areas of the device in accordance with the invention are wherever existing systems (products) cannot be used as the operating distance between the Hall probe and the switching magnet on the object is too large. In conventional systems, this size of the distance was the result of manufacturing tolerances or of special requirements of the application, for example when the displaceable object has a large displacement path relative to the stationary Hall probe.

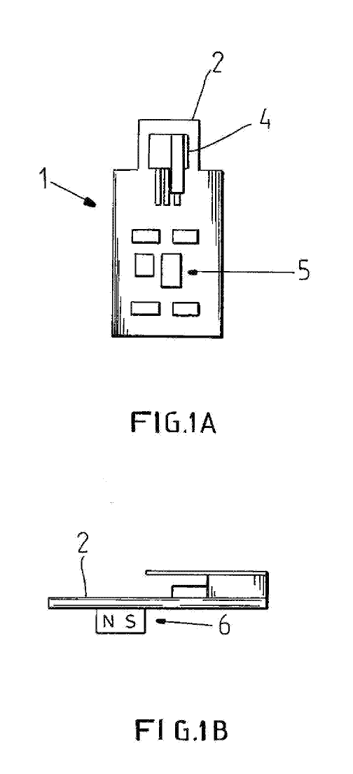

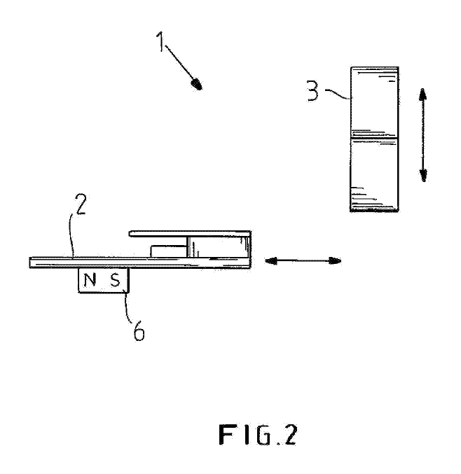

An embodiment of a device according to the invention for determining a position of the object is shown in detail in FIGS. 1 and 2 and described in the following.

A device shown at 1 for determining a position of an object that is not shown here has a Hall probe 2 that works together with a switching magnet 3. The switching magnet 3, which is mounted on the object, is formed by the object itself, or is integrated into the object, is displaceable with respect to the Hall probe 2, which has a Hall plate 4 made of highly permeable material without magnetic hysteresis. Moreover, an additional circuit 5 is provided, and electronic construction components of this additional circuit 5 are mounted on a printed circuit board of the device 1, just like the Hall probe 2. Not shown is an electrical connection between the device 1 and an evaluation circuit that analyzes the signals generated by the device 1 and outputs the position of the object in a suitable manner. This way, the position of the object can be outputted continuously or discontinuously (e.g. belt buckle lock closed or open).

Finally a reset magnet 6 required to guarantee safe resetting is mounted on one side of device 1, preferably on the underside of the printed circuit board.

FIG. 2 also shows that the operating distance between the Hall probe 2 and the switching magnet is enlarged to the effect that in the horizontal direction distances of up to approximately 15 mm can be employed by the device 1 according to the invention and horizontal distances of up to approximately 20 mm, whereas corresponding prior-art devices were only able to work at horizontal and/or vertical distances up to at most 5 mm (about this, see for example, the direct mounting of the belt clasp relative to the magnet switch on the belt buckle switch as per EP 1 177 178 A1).

1. A device for determining a position of an object, the device having a Hall probe as well as a switching magnet that works together with Hall probe wherein the Hall probe has Hall plates and is provided with differential sensors that react to field differences between the Hall plates.

2. The device according to claim 1 wherein the differential sensors are designed to switch near zero, so that switching on takes place upon the influence of a magnetic flux by the switching magnet and switching off takes place when the magnetic flux inverts.

3. The device according to claim 1 wherein a ferromagnetic flux collector is provided close to at least one of the Hall plates.

4. The device according to claim 1, further comprising an erasing magnet.

5. The device according to claim 1 wherein the Hall probe is provided with a reset magnet.
